(19) United States
(12) Patent Application Publication
(10) Pub. No.: US 2005/0172624 A1
(43) Pub. Date: Aug. 11, 2005

(54) Method and device for converting thermal energy into kinetic energy

(75) Inventors: Camillo Holecek, Vienna (AT); Klaus Engelhart, Furth bei Goettweig (AT)

Correspondence Address: GREENBLUM & BERNSTEIN, P.L.C., 1950 ROLAND CLARKE PLACE, RESTON, VA, 20191, US

(73) Assignee: Donau Wind Erneuerbare Energiegewinnung und Beteiligungs GmbH & Co. KG., Klosterneuburg (AT)

(21) Appl. No.: 11/000,972

(22) Filed: Dec. 2, 2004

Related U.S. Application Data
(63) Continuation of application No. PCT/AT03/00160, filed on Jun. 2, 2003.

(30) Foreign Application Priority Data
Jun. 3, 2002 (AT) A 843/02
May 19, 2003 (AT) A 767/03

(51) Int. Cl. F02G 1/04; F01B 29/10

(52) U.S. Cl. 60/517

(57) ABSTRACT

Method and device for converting, thermal energy into kinetic energy . The device includes at least two enclosed chambers. Each enclosed chamber has an expansion chamber, a compression chamber, and a displacer. The device also includes at least one drive to move the displacers, at least one regenerator, and control units are also used. A machine is arranged between the at least two enclosed chambers. The method includes a compression phase where a medium is compressed with one displacer, a heat absorption phase where heat is absorbed in the at least one regenerator, an expansion phase where heat is supplied in an expansion chamber and guided through the machine to release effective work, and a heat dissipation phase where heat is dissipated in the at least one regenerator and returned to the compression chamber. The medium flows back and forth between the at least two enclosed chambers. Heat absorption phase occurs before the machine and heat dissipation phase occurs after the machine. This Abstract is not intended to define the invention disclosed in the specification, nor intended to limit the scope of the invention in any way.

### CROSS-REFERENCE TO RELATED APPLICATIONS

The instant application is a continuation of International Application No. PCT/AT03/00160 filed on Jun. 2, 2003 and published as International Publication WO 03/102403 on Dec. 11, 2003, the disclosure of which is hereby expressly incorporated by reference hereto in its entirety. The instant application also claims priority under 35 U.S.C. § 119 of Austrian Application Nos. A 843/02, filed on Jun. 3, 2002 and A 767/03, filed on May 19, 2003.

### BACKGROUND OF THE INVENTION

1. Field of the Invention

The invention relates to a method for converting thermal energy into kinetic energy, whereby a medium undergoes the following changes of state in at least one chamber separated by a displacer: compression, preferably isothermal compression, with thermal dissipation in a compression chamber; heat absorption, preferably isochoric heat absorption, in a regenerator during passage of the medium from a compression chamber to an expansion chamber; expansion, preferably isothermal expansion, with heat supply in an expansion chamber and dissipation of effective work; and heat dissipation, preferably isochoric heat dissipation, in the regeneration on returning the medium to the compression chamber.

The invention also relates to a device for implementation of the method.

2. Discussion of Background Information

Energy cannot be “created” in the sense of new generation. Energy is present in nature in a wide variety of forms, but not every existing form of energy can be used equally for human needs. The energy contained in wood is very useful for heating purposes, for example, but is not very suitable for the generation of light or cold for the refrigerator, etc.

Although there are almost ideally available forms of energy for very specific applications, such as for example petroleum for cars, or natural gas for industrial heating, the universally applicable form of energy in the mind of humans is electric energy. However, it is virtually non-existent in nature in the form that we know.

That means that an available form of energy must first be converted into electric energy in several steps—and with varying degrees of effectiveness. If you take for example fossil sources of energy such as coal, natural gas and petroleum, which have stored the energy of the sun in chemical form for millions of years, to generate electric energy, three conversion processes, and the relevant industrial plant, are necessary. First the stored chemical energy is converted into heat through combustion. The heat is used to generate high-tension steam, which is converts the heat into kinetic energy in the steam turbine. The steam turbine drives the generator in which the kinetic energy is finally converted into electric energy.

Each of these energy conversions has a specific degree of efficiency, i.e., energy is lost every time and the overall efficiency is accordingly low. For example, only some 40% of the energy stored in coal, natural gas and petroleum can be converted into electric energy. The remaining 60% are lost to use in the form of electricity as so-called waste heat.

In other conversion processes, such as e.g., the conversion of chemical energy in petroleum into kinetic energy to drive cars, ships, trains or even aircraft, the efficiency is no better either, although the conversion chain in these processes is shorter.

If you only look at the huge amounts of electricity consumed worldwide, for instance, you can see what enormous quantities of energy cannot be used and are lost. The loss of primary energy not usable for conversion into electric energy is already a major problem, especially because of the waste of limited resources, but the environmental pollution inseparably associated with the conversion of chemical energy into thermal energy through combustion is a much more serious problem for future generations, such as climate changes due to greenhouse gases, as shown by the CO₂ problem, for example.

Therefore, it is not surprising that man has for decades been trying to improve and optimize the conversion processes, and also to make use of a part of the waste heat, such as e.g., in district heating. Use of a part of the waste heat from thermal power plants for heating purposes is already a significant contribution towards improving the efficiency of conversion. The efforts to convert other forms of energy, such as e.g., wind energy or solar energy, into electric energy are also producing first results.

Efforts to shorten the conversion chain by applying other conversion processes, and thus to improve the overall degree of efficiency, are also very promising. An interesting such conversion process has been realized in the Stirling motor. The Stirling motor can convert thermal energy directly into kinetic energy without the “detour” via steam.

After the steam engine, the Stirling motor is the second-oldest heat engine, i.e. a machine that can convert thermal energy into kinetic energy. And although the Stirling motor has a significantly higher efficiency that the steam engine and the carburetor or diesel engine on principle, it has still not become very widespread. Whereas the steam engine and the carburetor or diesel motor were constantly developed further, in order to achieve not only the satisfactory lifetime but above all the right performance with considerably improved efficiency, the Stirling motor has almost sunk into oblivion. Only recently it has started to receive more attention due to its lower environmental burden and independence of the heat source. However, a great deal of research and development is still necessary for it to achieve the same degree of “maturity” as the modem steam engine or carburetor motor in cars.

Considerable development work is still necessary, for example, to bring the efficiency of a built Stirling motor up to the efficiency of an ideal Stirling motor, which is identical to that of the Carnot process. For a possible mobile use, work will have to be invested primarily in increasing the performance and improving the dynamic behavior during rapid load switches.

The most important advantages of the Stirling motor compared with conventional heat engines, although they still have not been realized satisfactorily due to this development deficit, are: it works with any heat source, such as e.g., solar or process heat, combustion of biomass, landfill gas or other incinerable waste right down to waste, etc.; continuous heat supply, i.e., combustion under optimal conditions is possible, so that the exhaust contains hardly any pollutants; closed cycle—the medium does not have to be renewed constantly; due to the thermodynamically favorable process, very high degrees of efficiency can generally be expected—even in the partial load range; and extremely smooth running and noiseless.

Currently, three different types of Stirling motor are distinguished in terms of embodiment: type α (alpha), type β (beta) and type γ (gamma). These types of Stirling motors differ primarily in terms of function principle and structural design.

The ideal Stirling process corresponds with a Carnot process and therefore has a very high degree of efficiency. In practice, however, exact implementation, i.e., an exact copy of the ideal, or rather the theoretical, process is not possible. In embodied machines, a number of design-related deviations have to be accepted that have a negative effect on efficiency and performance.

In the Stirling motors designed or built to date, for instance, it has not been possible to realize either isochoric heat absorption or isochoric heat dissipation, nor isothermal compression or isothermal expansion. The main reasons for this lie primarily in the inevitable clearance volumes and the continuous instead of discontinuous volume change. Piston and displacer are moved by crank drives with flywheels, so that although there is a reversal of motion at the dead centers, there is no short standstill as required by the theoretical process.

The three types, the α, β, and γ motors, correspond with the three basic design solutions developed to date in order to imitate the ideal Stirling process as well as possible in the embodied machines.

In the α motor, two pistons in separate cylinders are used, whereby one piston is arranged in the hot expansion chamber and the other is in the cold compression chamber. Depending on the step or crankshaft angle, both pistons are either working pistons and then again displacers.

The big disadvantage of α motors is the piston packing in the hot expansion chamber, which greatly limits the lifetime of the motor and for which a satisfactory solution has not been found to date. Another disadvantage is the crank drive with the associated major deviation from the theoretical process and the low degree of efficiency.

So far, a number of different cylinder arrangements have been developed, such as parallel, aligned opposite, parallel opposite, V cylinders or the Finkelstein rotation cylinder, etc., which all function in the same way, have the same weaknesses, and the same low degree of efficiency.

In the β machine, a piston and displacer are used, whereby both piston and displacer are arranged in the same cylinder. For the complicated motion of piston and displacer, which depending on cycle move towards each other, then again in the same direction, for example, towards the crankshaft, or one is or should be at a standstill while the other is moving, complex gears such as e.g., rhombic gears are required.

The major disadvantage of β machines, similar to the α machines, is seals running dry. Furthermore the motion of piston and displacer, which acts like a crank drive despite complex gears, and therefore has dead centers with reversal of motion, but no real standstill. In the β type, the degree of efficiency actually achieved by embodied Stirling motors is far removed from the efficiency of the ideal Stirling process.

Another major disadvantage of the β machines is the complex sealing system of the displacer slide rod in the compression piston. Because piston and displacer are arranged in the same cylinder, the displacer slide rod runs through the compression piston.

A number of different embodiments of the β machines have been developed to date, such as e.g., Rankine-Napie or Philips, without being able to influence the disadvantages of the β machine.

In the γ machine, piston and displacer are arranged in separate cylinders. This avoids the complex sealing system for the displacer slide rod in the compression piston. In return, the dead volume detrimental to efficiency is increased.

The greatest disadvantages of γ machines, as already described for α and β machines, are the dry seals of the working piston. Moreover, the motion of piston and displacer caused by the crankshaft drive or crank-like drive, which makes a good approximation to the ideal Stirling process impossible in the embodied machines. Therefore, the γ machine also has a significantly poorer efficiency than the ideal Stirling process.

Another major disadvantage of γ machines is the greater dead volume, which has an additional negative impact on efficiency, and the relatively low compression ratio that can be achieved, so that only modest volume performance is possible.

In addition to the single-action machines described, double-action Stirling machines have also been developed and embodied, especially of the α type, for example the Franchot Stirling motor. In this motor, a Stirling process takes place in the space above the two pistons, but also below each piston, i.e., the two cylinders always perform two different cycles of two different Stirling processes at the same time with the top and bottom of the pistons. Thereby, the two pistons and their cylinders delimit four variable volumes, which can be regarded as pairs constituting two separate cc machines. Like in single-action α machines, the expansion-piston and the compression piston must have a phase displacement of about 90°.

The efficiency of double-action ax machines such as the Franchot Stirling motor is not better than that of single-action α machines. The serious disadvantages and problems are also the same. Merely the volume performance can be improved through compactness.

The Siemens Stirling motor is also known, which embodies the standard configuration of most stronger Stirling motors with any number of cylinders, such as e.g., the 4-95′ of United Stirling with a mechanical capacity of approx. 52 kW. In this embodiment, a number of models have also been developed, such as e.g. arrangement of the cylinders in a row, in a “U” or “V” shape, in a rectangle or in a circle. Although the arrangement of heater, regenerator and cooler in the Siemens Stirling motor was chosen in such a way that the piston sealing in the casing is located in the cold section, the basic disadvantages of the α machines remain.

Attempts to embody the principle of the Stirling motor with free piston arrangements or as a circular piston motor, system Wankel, are also known. None of these embodiments has resulted in an improvement of efficiency; on the contrary, in addition to poorer efficiency compared with the α machines, the disadvantages and problems were only enhanced.

All these various embodiments of Stirling motors have the additional disadvantages due to the clearance volumes in heat exchangers, regenerators and return-flow pipes in common, which additionally lower the pressure ratio and thus the efficiency.

### SUMMARY OF THE INVENTION

The aim of the invention is to create a method of the type set out above, that on the one hand, avoids the above disadvantages and, on the other hand, makes it possible for the first time to embody a Stirling motor in such a way that its mode of action can be approximated to the ideal Stirling process much better than before. This aim is fulfilled by the invention.

The method according to the invention is characterized by the fact that the medium flows back and forth between at least two enclosed chambers. To release effective work, the medium is guided through a machine between the chambers. Heat absorption takes places before the machine and heat dissipation takes place after the machine. The medium is compressed in the chamber after heat dissipation. By way of a displacer, it subsequently flows from one side through the regenerator to the other side of the displacer. The flow of the medium is controlled using control units, in particular valves. Every displacer is moved by a drive. With this invention, it is for the first time possible to achieve a significantly higher efficiency than with any other embodiments of Stirling motors to date.

The higher efficiency is due primarily to the better approximation of the work process described to the theoretical cycle process. This is achieved with the method of the invention. Due to the temperature difference of the medium in the two coupled chambers, and the resulting pressure differentials, it flows into the cold chamber and thereby performs work through a work machine. The resulting compensation state is due to the fact that the greater part of the medium is in the cold chamber. In the subsequent isochoric regenerator cycle, with heat supply, the pressure differential builds up inversely between the two chambers and is again converted into work through the work machine. This behavior is in analogy to an oscillating circuit and with a constant Carnot efficiency it makes a higher power density with reference to the volume of medium possible than in the theoretical, ideal Stirling process.

In a special embodiment of the invention, the chamber is separated into a double-action chamber by the displacer. Thus, the process can be speeded up, since return-flow pipes are not required. Moreover, seals against any buffer space otherwise required are dispensed with.

In accordance with a special feature of the invention, each displacer is moved by a separate drive. In accordance with this feature of the invention, there are no crank drives or crank-like drives, which are mainly responsible for the poor approximation of the embodied processes to the ideal Stirling process. Instead of the crank drives, a linear drive is used that can be controlled independently from other movements, so that any number of standstill times of any length can be achieved in the displaces, for example.

In accordance with another embodiment of the invention, the displacers in the coupled chambers are moved by a drive via a rigid connection. This allows for a simple design, whereby, for example, two hot and two cold chambers are coupled with each other. This allows complete immersion of the hot-hot chambers in the heat source, and immersion of the cold-cold chambers in the cold source. And this occurs without suffering losses through heat conduction between warm and cold source medium. The two displacers are connected by a rigid slide rod that absorbs the forces acting between the displacers. To move the displacers, only the frictional drag and flow losses have to be overcome. The regenerators may also be located within or outside the slide rod. The slide rod itself does not have to be sealed off. The theoretical power density with reference to the volume of medium is higher than in the ideal Stirling process. This embodiment allows the use of low temperature for power generation and for the generation of cold.

In accordance with a special embodiment of the invention, the chamber is divided by the displacer into an expansion chamber and a compression chamber, whereby the medium used for effective work, after exiting the expansion chamber through the regenerator allocated to this chamber for dissipation of effective work through the work machine and after the work machine, possibly with output of cold, flows into the compression chamber of the coupled chamber and then through movement of the displacer flows from the compression side through the regenerator allocated to this chamber into the expansion chamber of the same chamber. This embodiment is the so-called “cold” motor. The work machine can be designed very simply, since it is not subjected to high temperature stress. Additionally, cold can be generated through expansion of the cold medium cooled by the generator, which can be utilized before flowing into the cold workspace through a heat exchanger. The efficiency and power density is higher than in a Stirling motor of type γ that has the piston flanged onto the cold side.

In accordance with another embodiment of the invention, the chamber is separated by the displacer into an expansion chamber and a compression chamber, whereby the medium used for effective work, after exiting the expansion chamber for dissipation of effective work, possibly through a heater, flows through the work machine and subsequently through the regenerator and possibly through a compressor, possibly through an additional cooler, into the compression chamber of the coupled chamber, and subsequently through movement of the displacer flows from the compression side through the regenerator allocated to this chamber into the expansion chamber of the same chamber. This embodiment is the so-called “hot” motor. The theoretical efficiency of this type is close to that of the Carnot efficiency, the theoretical power density with reference to the volume of the medium is higher than in the ideal Stirling process.

In accordance with yet another embodiment of the invention, the chamber is divided by the displacer into two expansion chambers and compression chambers each, whereby the medium used for effective work, after exiting an expansion chamber through the regenerator allocated to this chamber for dissipation of effective work through the work machine and after the work machine flows into the compression chamber of the coupled chamber and then through movement of the displacer flows from the compression side through the regenerator allocated to this chamber into the other expansion chamber of the same chamber. As already mentioned, this “low temperature” motor allows low temperature to be utilized both for power generation and for the generation of cold.

In accordance with another special embodiment of the invention, heat absorption is isobaric, in particular, immediately before the work machine. The major advantage must be seen in the fact that the temperature in the displacers is limited to the maximum regenerator temperature, whereby the regenerator temperature is lower than the heater temperature.

In accordance with an advantageous embodiment of the invention, compression is achieved by pressure equalization and/or by a compressor. If compression is to be achieved solely by way of pressure equalization, one rotating machine, i.e., the compressor, can be dispensed with. This certainly makes the process simpler. If a compressor is integrated, an even higher efficiency is achieved.

It is also an aim of the invention, however, to provide a device for implementation of the method.

The device for implementation of the method in accordance with the invention is characterized by the fact that at least two enclosed chambers are provided. Each chamber is divided into two sections by a displacer which can be moved by a drive. One section contains a heater and the other section a cooler. Each chamber has a regenerator allocated to it. Both sections are connected to this regenerator. At least one section of each chamber is connected to a work machine. The section used for subsequent dissipation of effective work is connected to the corresponding section of the other chamber. Control units, in particular valves, are provided to control the medium. As already mentioned above, a higher power density is achieved with the device in accordance with the invention.

Another advantage of the device in accordance with the invention must be seen in the fact that the machine can be operated with a low clock speed. The chambers have no real piston seals and thus circumvent the sealing problem, which occurs particularly at greater piston volumes. By eliminating this problem, large-volume chambers can be used, which can be operated at low clock speeds and discontinuously. Thus, an approximation to the ideal Stirling process is achieved.

With the lower clock speed and thus longer heat transition time than in conventional Stirling motors, isothermal processes can be realized better. The large heat transition surfaces in the chambers accommodate the use of biomass fuels.

Another advantage is found in minimization of the clearance volume. The clearance volume is the volume not involved in the thermodynamic process, which as a result has a detrimental effect on efficiency. It is produced virtually through sinus movement of the piston, and in real terms by the volume of the regenerator, the heater pipe, etc., through which the medium flows. The ratio of large-volume chambers and by comparison small-volume elements such as work machine, regenerator, heater and cooler results in a favorable ratio between clearance volume and work volume, and is a significantly lower than that of the machines currently embodied.

The minimization of drive forces is also advantageous. They are made up of the flow resistance of pressing the medium through between the chambers isochorically, activating the valves, and possibly compression of the medium by a compressor. One of the main components, friction of the dry-running piston sealing rings together with friction of the crank drive, is eliminated.

In summary, it can therefore be said that through the elimination of moving seals that are under temperature stress and run dry, which were the main problem to date, it is possible to produce this motor in standard mechanical engineering. The separation of chamber and work machine allows the use of standard machine elements. Due to the rapidly rotating work machine, the generator has a smaller rated size. Elimination of the mechanical drive unit also simplifies the design. The displacer does not have to be synchronized with the work machine, the optimal work points can be set separately from each other.

In accordance with a special feature of the invention, at least one control unit, in particular a valve, is provided in the connections between the work machine and the individual sections. It serves to uncouple the work cycle and the regenerator cycle. Instead of control via valves, slit control could also be used.

In accordance with another special feature of the invention, four, six or more even-numbered chambers are provided, whereby the chambers are always coupled in pairs. With the increasing number of coupled chairs, the process-related waviness at the work machine is reduced and the regenerator cycle can be extended by comparison with the work cycle.

In accordance with a very special feature of the invention, the work machine is a turbine, in particular an axial, radial or Tesla turbine. The use of turbines allows the elimination of moving seals subject to temperature stress and running dry, which are the main problem in Stirling motors driven by pistons. With the disk or Tesla turbine, in particular, better isothermal expansion or compression is possible.

In accordance with one embodiment of the invention, the work machine is a piston motor. This embodiment has the advantage that it is cheap and can be built using standard components.

In accordance with a further embodiment of the invention, the work machine is a screw motor. Like the turbines, the screw motor has the advantage of eliminating seals.

In accordance with a special embodiment of the invention, the drive for the displacer is a linear drive. The linear drive guarantees accurately controllable acceleration and braking of the displacer. This makes discontinuous movement in accordance with the ideal thermodynamic process possible with low losses. All passages and thus seals for rods or crank drive can thus be eliminated. A possible rapid power control is possible instantaneously by changing the displacer clock speed and does not have to be induced by changing the upper temperature. Thus, very good control is possible in the partial load range.

In accordance with another feature of the invention, a heater is included upstream and/or downstream from the regenerator. The heater supplies energy to the medium in addition to the heater head in the chamber, thus enlarging the total absorption surface in the hot area.

A special embodiment of the invention is characterized by the fact that the chamber is divided by the displacer into an expansion chamber and a compression chamber. The expansion chamber is connected to the regenerator allocated to this chamber and the regenerator is connected to the work machine. The outflow side of the work machine is connected to the compression chamber of the coupled other chamber. This compression chamber is connected to the expansion chamber of the same chamber via the regenerator allocated to this chamber. One control unit each, in particular, a valve, is provided between regenerator and inflow side of the work machine, and outflow side of the work machine and compression chamber. Here, the same advantages apply accordingly, as already described above for the “cold” motor.

Another special embodiment of the invention is characterized by the fact that the chamber is divided by the displacer into an expansion chamber and a compression chamber. The expansion chamber is connected to the inflow side of the work machine. The outflow side of the work machine is connected to the compression chamber of the coupled other chamber through the regenerator and possibly through a compressor. This compression chamber is connected to the expansion chamber of the same chamber through the regenerator allocated to this chamber. One control unit each, in particular, a valve, is provided between expansion chamber and inflow side of the work machine, and outflow side of the regenerator and compression chamber. Here, the same advantages apply accordingly, as already described above for the “hot” motor.

An alternative embodiment of the invention is characterized by the fact that the chamber is divided by the displacer into two expansion chambers and two compression chambers. Each expansion chamber is connected to the inflow side of the work machine through a regenerator and the outflow side of the work machine is connected to the compression chamber of the coupled other chamber. This compression chamber is connected to the expansion chamber of the other chamber through a regenerator. One control unit each, in particular, a valve, is provided between the regenerator downstream from the expansion chamber and the inflow side of the work machine, and the outflow side of the work machine and the compression chamber. Here the same advantages apply accordingly, as already described above for the “low-temperature” motor.

Naturally, the hot gasses could also be expanded, in accordance with the work principle of the hot motor.

Another embodiment of the invention is characterized by the fact that a heater is provided in flow direction after the section connected to the work machine. This allows the work machine to achieve higher temperatures, which result in a better power yield.

In accordance with an advantageous embodiment of the invention, the heater is locally separated from the section, for example, in the combustion chamber of a heating boiler. Thus, only the elements used as heater are subject to highest temperature stress, so that only these parts have to be dimensioned accordingly.

The invention also provides for a method for converting thermal energy into kinetic energy with a device comprising at least two enclosed chambers. Each of the at least two enclosed chambers comprises an expansion chamber, a compression chamber, and a displacer, and wherein the device further comprises at least one drive for moving the displacers, at least one regenerator, a machine arranged between the at least two enclosed chambers, and control units. The method comprises a compression phase wherein a medium is compressed with one displacer in one of the at least two enclosed chambers, a heat absorption phase wherein heat is absorbed in the at least one regenerator during passage of the medium from the compression chamber of the one of the at least two enclosed chambers to an expansion chamber of at least one of the at least two enclosed chambers, an expansion phase wherein heat is supplied in an expansion chamber of at least one of the at least two enclosed chambers and guided through the machine to release effective work, and a heat dissipation phase wherein heat is dissipated in the at least one regenerator and the medium is returned to the compression chamber of the one of the at least two enclosed chambers. The medium flows back and forth between the at least two enclosed chambers, through the at least one regenerator, and through the machine. Moreover, the heat absorption phase occurs before the machine and the heat dissipation phase occurs after the machine.

The compression phase may occur after the heat dissipation phase. The method may further comprise controlling with the control units a flow of the medium from the compression chamber of the one of the at least two enclosed chambers, through the at least one regenerator, and to the expansion chamber of at least one of the at least two enclosed chambers. The control units may comprise valves. The at least one drive for moving the displacers may comprise a first drive for moving one displacer and a second drive for moving another displacer. The compression phase may comprise at least one of an isothermal compression phase and a compression phase utilizing thermal dissipation. The heat absorption phase may comprise isochoric heat absorption. The expansion phase may comprise isothermal expansion. The heat dissipation phase may comprise isochoric heat dissipation. Each displacer may divide each of the at least two enclosed chambers into the compression chamber and the expansion chamber. Each of at least two enclosed chambers may comprise a double-action chamber. Each displacer may be movable via a separate drive. The displacers may be connected to each other via a rigid connection, whereby the displacers are movable by the at least one drive and the rigid connection.

After the machine, the medium may flow from the compression chamber through the at least one regenerator and to the expansion chamber of the one of the at least two enclosed chambers. After the machine, the medium may flow from the compression chamber through the at least one regenerator and to the expansion chamber of another of the at least two enclosed chambers. After the machine, cold may be output and the medium may flow from one of the compression chambers, through the at least one regenerator, and to the expansion chamber arranged on an opposite side of the displacer associated with the expansion and compression chambers.

The method may further comprise a heater, wherein the medium flows through the heater, through the machine, and then through the at least one regenerator. The method may further comprise a compressor, wherein the medium flows through the heater, through the machine, then through the at least one regenerator and the compressor. The method may further comprise a cooler, wherein the medium flows through the heater, through the machine, then through the at least one regenerator and the compressor, and through the cooler. The medium may flow from the cooler to one of the compression chambers of the at least two enclosed chambers, then through the at least one regenerator and then to the expansion chamber of the one of the at least two enclosed chambers.

The at least one regenerator may comprise a first regenerator and a second regenerator, the first regenerator being coupled to a first of the at least two enclosed chambers and the second regenerator being coupled to a second of the at least two enclosed chambers. The medium may flow from the compression chamber of the first enclosed chamber through the first regenerator and to the expansion chamber of the second enclosed chamber.

The method may further comprise an isobaric heat absorption phase. The isobaric heat absorption phase may occur immediately before the medium flows into machine.

The method may further comprise equalizing a pressure in the device. The method may further comprise a compressor structured and arranged to equalize a pressure in the device.

The invention also provides for a device for converting thermal energy into kinetic energy. The device comprises at least two enclosed chambers, in which each of the at least two enclosed chambers comprising an expansion chamber, a compression chamber, and a displacer. The device also includes at least one drive for moving the displacers, a first regenerator associated with one of the at least two enclosed chambers, a second regenerator associated with another of the at least two enclosed chambers, a machine which produces work arranged between the at least two enclosed chambers, control units arranged to control a flow of medium through the device, a heater, a cooler, at least one of the compression and expansion chambers of the one of the two enclosed chambers being coupled to the machine, and at least another of the compression and expansion chambers of the other of the two enclosed chambers being coupled to the machine. The medium flows back and forth between the at least two enclosed chambers, through the first and second regenerators, through the heater and the cooler, and through the machine.

At least one of the control units may comprise a valve. At least one of the control units may be arranged in a connection between the machine and one of the at least two enclosed chambers. The at least two enclosed chambers may comprise an even-number of chambers. The machine may be a turbine. The turbine may comprise one of an axial turbine, a radial turbine and a Tesla turbine. The machine may be a piston motor. The machine may be a screw motor. The at least one drive may comprise a linear drive.

The heater may be arranged upstream of the first regenerator. The cooler may be arranged downstream of the first regenerator. The first regenerator may be coupled to the one of the at least two enclosed chambers and the second regenerator may be coupled to the other of the at least two enclosed chambers. The one of the at least two enclosed chambers is coupled to an inflow side of the machine, the compression chamber of the other of the at least two enclosed chambers is coupled to an outflow side of the machine, and the compression chamber of the other of the at least two enclosed chambers is coupled via the second regenerator to the expansion chamber of the other of the at least two enclosed chambers. One of the control units may be arranged between the first regenerator and the inflow side of the machine and another of the control units may be arranged between the outflow side of the machine and the compression chamber of the other of the at least two enclosed chambers.

The device may further comprise a compressor, wherein the compressor is arranged between an outflow side of the machine and the compression chamber of the other of the at least two enclosed chambers. One of the control units may be arranged between the expansion chamber of the one of the at least two enclosed chambers and an inflow side of the machine, and another of the control units may be arranged between an outflow side of the first regenerator and the compression chamber of the other of the at least two enclosed chambers. Each of the expansion chambers may be coupled to an inflow side of the machine via the first and second regenerators. An outflow side of the machine may be coupled to the compression chamber of the other of the at least two chambers and the compression chamber of the other of the at least two enclosed chambers may be coupled via the second regenerator to the expansion chamber of the other of the at least one enclosed chambers. One of the control units may be arranged between the expansion chamber of the one of the at least two enclosed chambers and the inflow side of the machine, and another of the control units may be arranged between the outflow side of the machine and the compression chamber of the other of the at least two enclosed chambers.

The heater may be coupled to the machine. The heater may be separated from the at least two enclosed chambers. The heater may be separated from the first and second regenerators. The heater may be arranged within a combustion chamber of a heating boiler.

The invention also provides for a method for converting thermal energy into kinetic energy with a device comprising first and second enclosed chambers, in which each of the first and second enclosed chambers comprising an expansion chamber, a compression chamber, and a displacer. The device also includes at least one drive for moving the displacers, a first regenerator associated with the first enclosed chamber, a second regenerator associated with the second enclosed chamber, a machine arranged between the first and second enclosed chambers, and a plurality of control units controlling the flow of medium through the device. The method comprises a compression phase wherein the medium is compressed with the displacer in the first enclosed chamber, a heat absorption phase wherein heat is absorbed in the first regenerator during passage of the medium from the compression chamber of the first enclosed chamber to an expansion chamber of the second enclosed chamber, an expansion phase wherein heat is supplied in the expansion chamber of the second enclosed chamber and guided through the machine to release effective work, and a heat dissipation phase wherein heat is dissipated in the second regenerator and the medium is returned to the compression chamber of the first enclosed chamber. The medium flows back and forth between the first and second enclosed chambers, through the first and second regenerators, and through the machine. The heat absorption phase occurs before the medium flows through the machine and the heat dissipation phase occurs after the medium flows through the machine.

The invention also provides for a device for converting thermal energy into kinetic energy, wherein the device comprises first and second enclosed chambers, in which each of the first and second enclosed chambers comprising an expansion chamber, a compression chamber, and a displacer. The device also includes at least one drive for moving the displacers within the first and second enclosed chambers, a first regenerator associated with the first enclosed chamber, a second regenerator associated with the second enclosed chamber, a machine which produces work arranged between the first and second enclosed chambers, a plurality of valves arranged to control a flow of medium through the device, at least one of the compression and expansion chambers of the first enclosed chamber being coupled to the machine, and at least one of the compression and expansion chambers of the second enclosed chamber being coupled to the machine. The medium flows back and forth between the first and second enclosed chambers, through the first and second regenerators, and through the machine. Heat absorption occurs before the medium flows through the machine and heat dissipation occurs after the medium flows through the machine.

### BRIEF DESCRIPTION OF THE DRAWINGS

The invention is explained in more detail based on the design examples illustrated in the drawings wherein:

FIG. 1 shows a device for transformation of thermal energy into kinetic energy as a hot motor;

FIG. 2 shows a device as a cold motor;

FIG. 3 shows a device as a low-temperature motor;

FIG. 4 shows an embodiment of the device with locally separated heaters; and

FIG. 5 shows schematics of the mode of action of a device.

### DETAILED DESCRIPTION OF THE PRESENT INVENTION

By way of introduction, it is noted that in the described embodiment the same parts and the same states are allocated the same reference numbers and the same component names, whereby the disclosures contained throughout the description can be applied by analogy to the same parts and the same states with the same reference numbers or same component names.

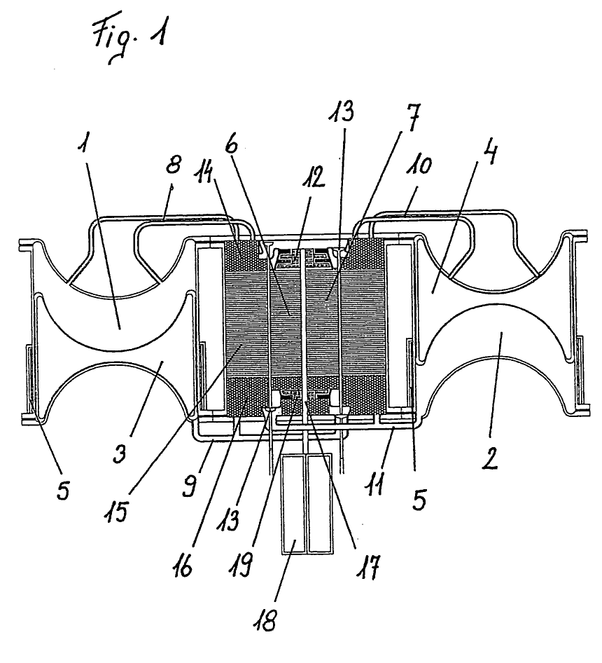

FIG. 1 shows a device using a medium for conversion of thermal energy into kinetic energy which has two enclosed chambers 1, 2. Each chamber 1, 2 is divided by a movable displacer 3, 4 into two sections, namely an expansion chamber and a compression chamber. Each displacer 3, 4 can be moved by a drive 5, which can be, in particular, a linear drive. Each chamber 1, 2 has a regenerator 6, 7 allocated to it. Both sections of the chambers 1, 2 are connected to regenerators 6, 7 via pipes 8, 9 and 10, 11.

One section, i.e., the expansion chamber, of each chamber 1, 2 is connected to a work machine 12. The expansion chamber of chamber 1, used for dissipation of effective work, is connected to the corresponding section—i.e., the compression chamber of chamber 2 after the work machine 12.

To control the medium, control units, which can be, in particular, valves 13, are provided. The control units 13 are arranged between the work machine 12 and the individual sections of the chambers 1, 2. However, slit control could also be used instead of the valves 13.

The work machine 12 can have the form of a turbine, in particular, an axial or radial turbine. Naturally, the work machine 12 can also be a piston or screw motor. The work machine 12 is connected to the generator 18 by a shaft 17.

In the ideal process, the medium undergoes the following changes of state: isothermal compression with thermal dissipation in a compression chamber; isochoric heat absorption in a regenerator 6, 7 during transition of the medium from the compression chamber to the expansion chamber; isothermal expansion with heat supply in an expansion chamber and dissipation of effective work; and isochoric heat dissipation in the regenerator 6, 7 during return flow into the compression chamber.

Generally, it can be shown that the medium flows back and forth between the two double-action enclosed chambers 1, 2. To release effective work, the medium is guided through a work machine 12 between the chambers 1, 2. Subsequently, the medium flows in the double-action chamber 1, 2 by way of the displacer 3, 4 from one side through the regenerator 6, 7 to the other side of the displacer 3, 4, whereby the flow of medium is controlled via the valves 13 and each displacer 3, 4 is moved by a drive 5.

As already mentioned, FIG. 1 shows the device, also referred to as 4-quadrant turbine, as a “hot” motor, wherein the medium is guided through the work machine 12 in its highest temperature state. The expansion chamber is connected to the inflow side of the work machine 12 and the outflow side of the work machine 12 is connected to the regenerator 6, 7 and through a compressor 19 to the compression chamber of the coupled other chamber 2. This compression chamber is connected to through the regenerator 7 allocated to this chamber 2 with the expansion chamber of the same chamber 2. One valve 13 each is provided between the expansion chamber and the inflow side of the work machine 12, and the outflow side of the regenerator 7 and the compression chamber.

The regenerator 6, 7 consists of a heater 14, a coupled regenerator 15, and a cooler 16. The expansion chamber is connected to the heater 14 and the compression chamber is connected to the cooler 16. Moreover, the regenerator 6, 7 is divided vertically into individual sectors. These sectors are sealed off against each other. In the inner sectors, the medium flows from the work machine 12 to the compressor 19, and the outer sectors serve for the regenerator cycle of the medium.

The expansion chamber is connected to the heater 14 of the regenerator 6 allocated to this chamber 1, and the regenerator 6 is connected to the work machine 12. The outflow side of the work machine 12 is connected through the cooler 16 with the compression chamber of the coupled other chamber 2. This compression chamber is connected through the regenerator 7 allocated to this chamber 2 with the expansion chamber of the same chamber 2. A valve 13 each is provided between the regenerator 6, 7 and the inflow side of the work machine 12, and the outflow side of the work machine 12 and compressor 19, and the compression chamber.

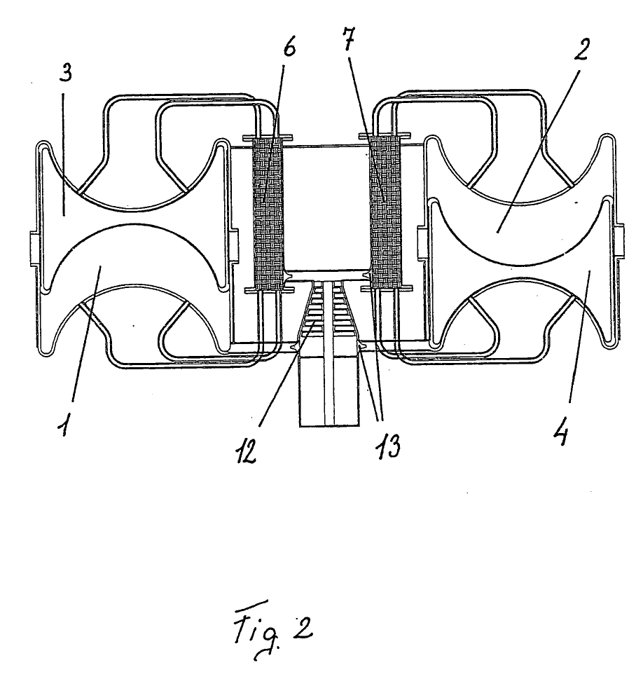

FIG. 2 shows the 4-quadrant turbine as a “cold” motor. The chamber 1, 2 is again divided by the displacer 3, 4 into an expansion chamber and a compression chamber.

In this case, the medium used for efficient work, after exiting the expansion chamber, flows through the regenerator 6 allocated to this chamber 1 to release effective work through the work machine 12, and after the work machine 12 into the compression chamber of the coupled chamber 2. Subsequently, the medium, through movement of the displacer 4, flows from the compression side through the regenerator 7 allocated to this chamber 2 into the expansion chamber of the same chamber 2.

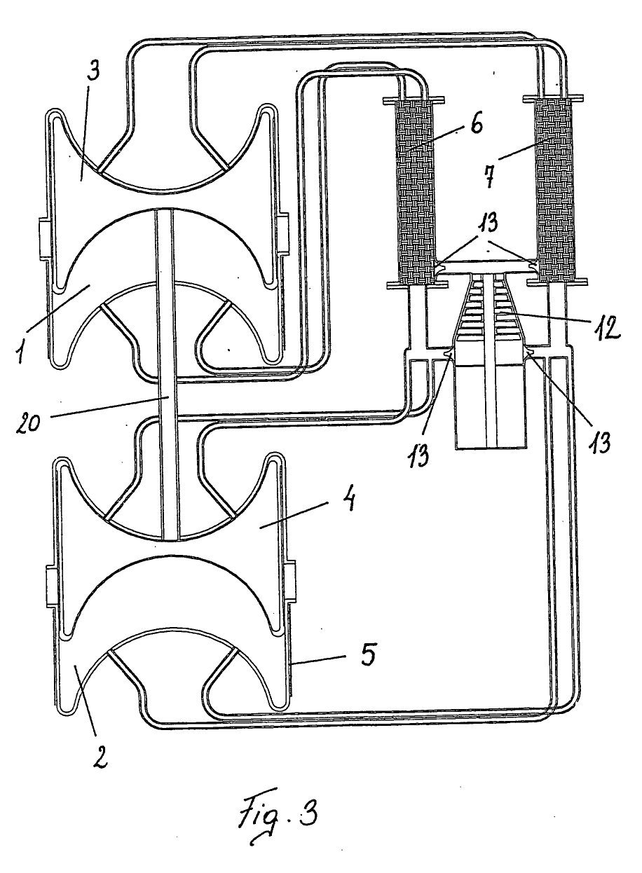

FIG. 3 shows the device as a low-temperature motor. In this device, the displacer 3, 4 is moved in a rigid connection 20 by a drive 5. The chamber 1, 2 is divided by the displacer 3, 4 into two expansion chambers and two compression chambers each. Each expansion chamber in chamber 1 is connected through a regenerator 6, 7 with the inflow side of the work machine 12, and the outflow side of the work machine 12 with the compression chamber of the coupled other chamber 2. This compression chamber is connected through the regenerators 6, 7 with the expansion chamber of the other chamber 1, whereby one valve 13 each is provided between the regenerator 6, 7 downstream from the expansion chamber and the inflow side of the work machine 12, and the outflow side of the work machine 12 and the compression chamber.

The medium used for efficient work, after exiting an expansion chamber, flows through the regenerator 6, 7 allocated to this chamber I to release effective work through the work machine 12, and after the work machine 12 into the compression chamber of the coupled chamber 2. Subsequently, the medium, through movement of the displacer 3, 4, flows from the compression side through the regenerator 6, 7 allocated to this chamber 2 into the expansion chamber of chamber 1.

To cool chamber 2, it can be arranged under the earth for example.

Moreover the displacers 3, 4 can also be designed as coupled membranes.

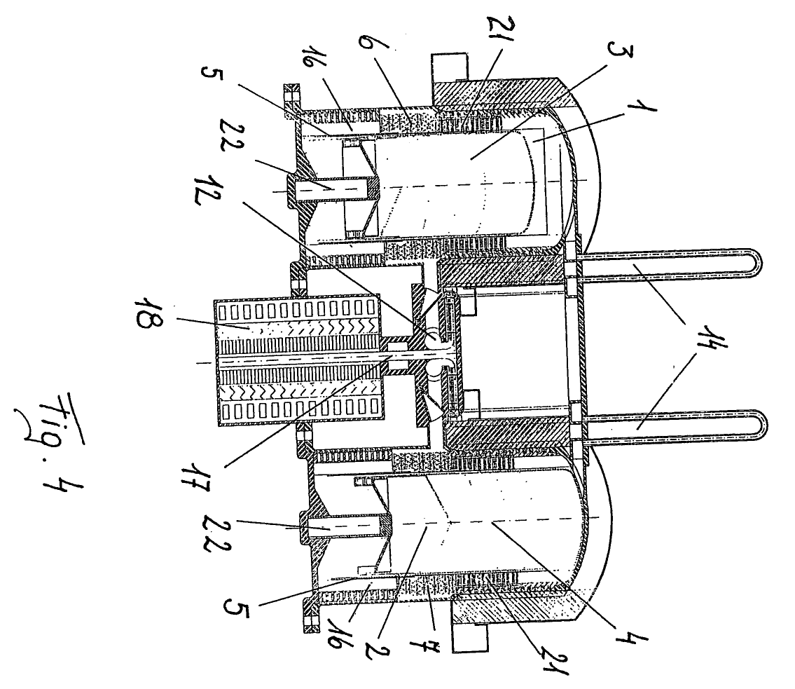

FIG. 4 also shows a device wherein each chamber 1, 2 is divided by the displacer 3, 4 into one expansion chamber and one compression chamber. Each displacer 3, 4 can be moved by a drive 5, in particular, by a linear drive. Moreover, each displacer 3, 4 is arranged in a guide 22. Each chamber 1, 2 has a regenerator 6, 7 allocated to it. Both sections of the chamber 1, 2 are connected to this regenerator 6, 7 by pipes.

Moreover, the expansion chamber is equipped with an intermediate heater 21. This intermediate heater 21 can be designed as a layered intermediate heater 21 or in the form of lamella packages. The compression chamber is equipped with a cooler 16.

The expansion chamber can possibly be connected through the intermediate heater 21 to a locally separated heater 14. The heater 14 could be arranged in a heating boiler. Isobar heating takes place in this heater 14. The medium flows from heater 14 through the work machine 12. The work machine 12, preferably a Tesla turbine, is coupled to generator 18 by a direct shaft 17.

The process is illustrated once more in summary. The compressed medium flows from the compression chamber of chamber 1 through the allocated regenerator 6 and intermediate heater 21 into the expansion chamber of the same chamber 1 and is thereby heated isochorically. The passage is actuated by movement of the displacer 3. After exiting the expansion chamber of chamber 1, the medium flows through the external heater 14, in which isobaric heat absorption takes place, to the work machine 12.

From the work machine 12, the medium flows through the regenerator 7 and the cooler 16 into the compression chamber of chamber 2 and is compressed isothermally by subsequent flow or by a compressor. The compression heat is dissipated in cooler 16 of chamber 2. Through movement of the displacer 4 in chamber 2, the compressed medium is passed through the regenerator 7 and the intermediate heater 21 into the expansion chamber of chamber 2.

After exiting the expansion chamber of chamber 2, the medium flows through the external heater 14, in which isobaric heat absorption takes place, to work machine 12. From work machine 12, the medium flows back to the compression chamber of chamber 1.

In principle, the medium flows in a figure of eight, whereby the work machine 12 is provided as the center. The individual process steps are controlled by the relevant valves—not shown.

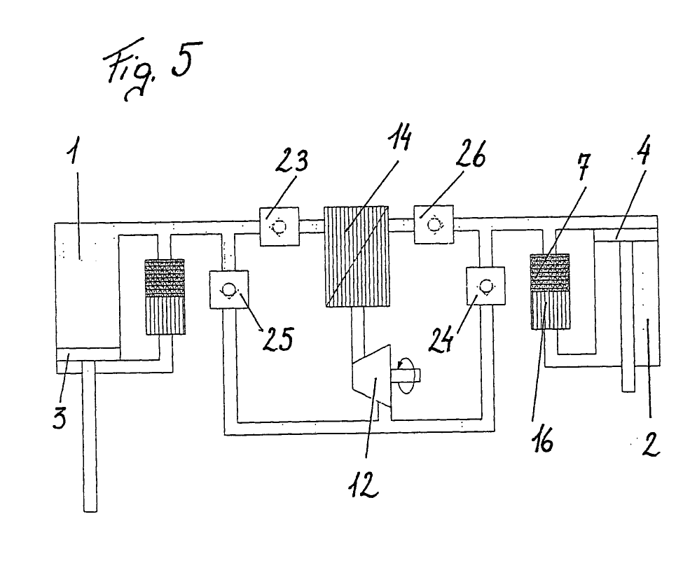

FIG. 5 describes the mode of action of the device with valve control based on a real example. In chamber 1 with displacer 3, the medium has a temperature To of 530° C. and a pressure Po of 30 bar. In chamber 2 with displacer 4, the temperature Pu is 30° C. and the pressure Pu is 10 bar. Due to the pressure differential created in the displacer cycle between chamber 1 and chamber 2, valve 23 and valve 24 opens in flow direction. The hot medium with a temperature of 530° C. flows out of chamber 1 through valve 23 into the heater 14, where it is overheated to 630° C. and then returned to 530° C. through polytropic relief in the work machine 12. Subsequently, the medium flows through valve 24, the regenerator 7, where it is cooled to 60° C., the cooler 16, where it is cooled to 30° C., to chamber 2. The valves 25 and 26 block the pressure differential and are not opened until after the subsequent regenerator cycle, i.e. in the next work cycle.

The regenerator cycle starts after the work cycle has produced pressure equalization between the chambers 1,2; i.e., the pressure is the same throughout the system (mean pressure). The displacers 3, 4 now move into the opposite dead center positions and thereby displace the medium through the regenerator-cooler unit to the other side of each displacer 3, 4. The isochoric heating (resp. cooling of the medium) that takes place thereby effects a change of pressure in the relevant chamber 1, 2; i.e., when cold is passed into hot, a pressure increase is effected, when hot is passed into cold a pressure reduction is effected. The regenerator cycle is thus ended and the pressure differential used for the subsequent work cycle.

In conclusion, it is noted that for better legibility, the individual components and assemblies shown in the drawings are not shown proportionally or to scale.

1. A method for converting thermal energy into kinetic energy with a device comprising at least two enclosed chambers, wherein each of the at least two enclosed chambers comprises an expansion chamber, a compression chamber, and a displacer, and wherein the device further comprises at least one drive for moving the displacers, at least one regenerator, a machine arranged between the at least two enclosed chambers, and control units, the method comprising:
a compression phase wherein a medium is compressed with one displacer in one of the at least two enclosed chambers;
a heat absorption phase wherein heat is absorbed in the at least one regenerator during passage of the medium from the compression chamber of the one of the at least two enclosed chambers to an expansion chamber of at least one of the at least two enclosed chambers;
an expansion phase wherein heat is supplied in an expansion chamber of at least one of the at least two enclosed chambers and guided through the machine to release effective work; and
a heat dissipation phase wherein heat is dissipated in the at least one regenerator and the medium is returned to the compression chamber of the one of the at least two enclosed chambers,
wherein the medium flows back and forth between the at least two enclosed chambers, through the at least one regenerator, and through the machine, and
whereby the heat absorption phase occurs before the machine and the heat dissipation phase occurs after the machine.

2. The method of claim 1, wherein the compression phase occurs after the heat dissipation phase.

3. The method of claim 1, further comprising controlling with the control units a flow of the medium from the compression chamber of the one of the at least two enclosed chambers, through the at least one regenerator, and to the expansion chamber of at least one of the at least two enclosed chambers.

4. The method of claim 1, wherein the control units comprise valves.

5. The method of claim 1, wherein the at least one drive for moving the displacers comprises a first drive for moving one displacer and a second drive for moving another displacer.

6. The method of claim 1, wherein the compression phase comprises at least one of an isothermal compression phase and a compression phase utilizing thermal dissipation.

7. The method of claim 1, wherein the heat absorption phase comprises isochoric heat absorption.

8. The method of claim 1, wherein the expansion phase comprises isothermal expansion.

9. The method of claim 1, wherein the heat dissipation phase comprises isochoric heat dissipation.

10. The method of claim 1, wherein each displacer divides each of the at least two enclosed chambers into the compression chamber and the expansion chamber.

11. The method of claim 1, wherein each of at least two enclosed chambers comprises a double-action chamber.

12. The method of claim 1, wherein each displacer is movable via a separate drive.

13. The method of claim 1, wherein the displacers are connected to each other via a rigid connection, whereby the displacers are movable by the at least one drive and the rigid connection.

14. The method of claim 1, wherein, after the machine, the medium flows from the compression chamber through the at least one regenerator and to the expansion chamber of the one of the at least two enclosed chambers.

15. The method of claim 1, wherein, after the machine, the medium flows from the compression chamber through the at least one regenerator and to the expansion chamber of another of the at least two enclosed chambers.

16. The method of claim 1, wherein, after the machine, cold is output and the medium flows from one of the compression chambers, through the at least one regenerator, and to the expansion chamber arranged on an opposite side of the displacer associated with the expansion and compression chambers.

17. The method of claim 1, further comprising a heater, wherein the medium flows through the heater, through the machine, and then through the at least one regenerator.

18. The method of claim 17, further comprising a compressor, wherein the medium flows through the heater, through the machine, then through the at least one regenerator and the compressor.

19. The method of claim 18, further comprising a cooler, wherein the medium flows through the heater, through the machine, then through the at least one regenerator and the compressor, and through the cooler.

20. The method of claim 19, wherein the medium flows from the cooler to one of the compression chambers of the at least two enclosed chambers, then through the at least one regenerator and then to the expansion chamber of the one of the at least two enclosed chambers.

21. The method of claim 1, wherein the at least one regenerator comprises a first regenerator and a second regenerator, the first regenerator being coupled to a first of the at least two enclosed chambers and the second regenerator being coupled to a second of the at least two enclosed chambers.

22. The method of claim 21, wherein the medium flows from the compression chamber of the first enclosed chamber through the first regenerator and to the expansion chamber of the second enclosed chamber.

23. The method of claim 1, further comprising an isobaric heat absorption phase.

24. The method of claim 23, wherein the isobaric heat absorption phase occurs immediately before the medium flows into machine.

25. The method of claim 1, further comprising equalizing a pressure in the device.

26. The method of claim 1, further comprising a compressor structured and arranged to equalize a pressure in the device.

27. A device for converting thermal energy into kinetic energy, the device comprising:
at least two enclosed chambers;
each of the at least two enclosed chambers comprising an expansion chamber, a compression chamber, and a displacer;
at least one drive for moving the displacers;
a first regenerator associated with one of the at least two enclosed chambers;
a second regenerator associated with another of the at least two enclosed chambers;
a machine which produces work arranged between the at least two enclosed chambers;
control units arranged to control a flow of medium through the device;
a heater;
a cooler;
at least one of the compression and expansion chambers of the one of the at least two enclosed chambers being coupled to the machine; and
at least another of the compression and expansion chambers of the other of the at least two enclosed chambers being coupled to the machine,
wherein the medium flows back and forth between the at least two enclosed chambers, through the first and second regenerators, through the heater and the cooler, and through the machine.

28. The device of claim 27, wherein at least one of the control units comprises a valve.

29. The device of claim 27, wherein at least one of the control units is arranged in a connection between the machine and one of the at least two enclosed chambers.

30. The device of claim 27, wherein the at least two enclosed chambers comprises an even-number of chambers.

31. The device of claim 27, wherein the machine is a turbine.

32. The device of claim 31, wherein the turbine comprises one of an axial turbine, a radial turbine and a Tesla turbine.

33. The device of claim 27, wherein the machine is a piston motor.

34. The device of claim 27, wherein the machine is a screw motor.

35. The device of claim 27, wherein the at least one drive comprises a linear drive.

36. The device of claim 27, wherein the heater is arranged upstream of the first regenerator.

37. The device of claim 27, wherein the cooler is arranged downstream of the first regenerator.

38. The device of claim 27, wherein the first regenerator is coupled to the one of the at least two enclosed chambers and the second regenerator is coupled to the other of the at least two enclosed chambers, wherein the one of the at least two enclosed chambers is coupled to an inflow side of the machine, wherein the compression chamber of the other of the at least two enclosed chambers is coupled to an outflow side of the machine, and wherein the compression chamber of the other of the at least two enclosed chambers is coupled via the second regenerator to the expansion chamber of the other of the at least two enclosed chambers.

39. The device of claim 38, wherein one of the control units is arranged between the first regenerator and the inflow side of the machine and another of the control units is arranged between the outflow side of the machine and the compression chamber of the other of the at least two enclosed chambers.

40. The device of claim 27, further comprising a compressor, wherein the compressor is arranged between an outflow side of the machine and the compression chamber of the other of the at least two enclosed chambers.

41. The device of claim 27, wherein one of the control units is arranged between the expansion chamber of the one of the at least two enclosed chambers and an inflow side of the machine, and wherein another of the control units is arranged between an outflow side of the first regenerator and the compression chamber of the other of the at least two enclosed chambers.

42. The device of claim 27, wherein each of the expansion chambers is coupled to an inflow side of the machine via the first and second regenerators.

43. The device of claim 42, wherein an outflow side of the machine is coupled to the compression chamber of the other of the at least two chambers and the compression chamber of the other of the at least two enclosed chambers is coupled via the second regenerator to the expansion chamber of the other of the at least one enclosed chambers.

44. The device of claim 43, wherein one of the control units is arranged between the expansion chamber of the one of the at least two enclosed chambers and the inflow side of the machine, and wherein another of the control units is arranged between the outflow side of the machine and the compression chamber of the other of the at least two enclosed chambers.

45. The device of claim 27, wherein the heater is coupled to the machine.

46. The device of claim 27, wherein the heater separated from the at least two enclosed chambers.

47. The device of claim 27, wherein the heater is separated from the first and second regenerators.

48. The device of claim 27, wherein the heater is arranged within a combustion chamber of a heating boiler.

49. A method for converting thermal energy into kinetic energy with a device comprising first and second enclosed chambers, each of the first and second enclosed chambers comprising an expansion chamber, a compression chamber, and a displacer, at least one drive for moving the displacers, a first regenerator associated with the first enclosed chamber, a second regenerator associated with the second enclosed chamber, a machine arranged between the first and second enclosed chambers, and a plurality of control units controlling the flow of medium through the device, the method comprising:
a compression phase wherein the medium is compressed with the displacer in the first enclosed chamber;
a heat absorption phase wherein heat is absorbed in the first regenerator during passage of the medium from the compression chamber of the first enclosed chamber to an expansion chamber of the second enclosed chamber;
an expansion phase wherein heat is supplied in the expansion chamber of the second enclosed chamber and guided through the machine to release effective work; and
a heat dissipation phase wherein heat is dissipated in the second regenerator and the medium is returned to the compression chamber of the first enclosed chamber,
wherein the medium flows back and forth between the first and second enclosed chambers, through the first and second regenerators, and through the machine, and
whereby the heat absorption phase occurs before the medium flows through the machine and the heat dissipation phase occurs after the medium flows through the machine.

50. A device for converting thermal energy into kinetic energy, the device comprising:
first and second enclosed chambers;
each of the first and second enclosed chambers comprising an expansion chamber, a compression chamber, and a displacer;
at least one drive for moving the displacers within the first and second enclosed chambers;
a first regenerator associated with the first enclosed chamber;
a second regenerator associated with the second enclosed chamber;
a machine which produces work arranged between the first and second enclosed chambers;
a plurality of valves arranged to control a flow of medium through the device;
at least one of the compression and expansion chambers of the first enclosed chamber being coupled to the machine; and
at least one of the compression and expansion chambers of the second enclosed chamber being coupled to the machine,
wherein the medium flows back and forth between the first and second enclosed chambers, through the first and second regenerators, and through the machine, and
wherein heat absorption occurs before the medium flows through the machine and heat dissipation occurs after the medium flows through the machine.
